(19) United States
(12) Patent Application Publication
(10) Pub. No.: US 2022/0030675 A1
(43) Pub. Date: Jan. 27, 2022

(54) A MICROWAVE OVEN COOKING UTENSIL AND A METHOD FOR MANUFACTURING THE SAME

(71) Applicant: MAXELL, LTD., Otokuni-gun, Kyoto (JP)

(72) Inventors: Tsuyoshi MARO, Otokuni-gun (JP); Satoshi MATSUNUMA, Otokuni-gun (JP); Masayuki KATO, Osaka-shi (JP)

(73) Assignee: MAXELL, LTD., Otokuni-gun, Kyoto (JP)

(21) Appl. No.: 17/312,106

(22) PCT Filed: Mar. 13, 2020
(86) PCT No.: PCT/JP2020/011074

§ 371 Date: Jun. 9, 2021

(30) Foreign Application Priority Data
Mar. 19, 2019 (JP) 2019-051464

(51) Int. Cl. H05B 6/64; A47J 36/02; B65D 81/34

(52) U.S. Cl. CPC H05B 6/6408; H05B 6/6494; A47J 36/027; B65D 2581/3477; B65D 2581/3448; B65D 2581/3494; B65D 81/3453

(57) ABSTRACT

A method of manufacturing the microwave oven cooking utensil includes: an upper heating body and a lower heating body each of which absorbs a microwave and generates a heat; and a heating space for heating a food material located between the upper heating body and the lower heating body, the heating being performed from above and below at the same time. Here, the upper heating body and the lower heating body are each formed by including a heat generating part containing ferrite and a molded foam body.

### TECHNICAL FIELD

The present invention relates to a microwave oven cooking utensil, which is for heating up a food material in a microwave oven. This invention also relates to a method for manufacturing the microwave oven cooking utensil.

### BACKGROUND ART

As is well known, in a microwave oven, upon irradiating a water-containing food material with a microwave, water molecules having polar groups will absorb the microwave, and the water molecules in the food material are directly vibrated or rotated, thereby heating up the food material (being cooked).

When cooking with such a microwave oven, a cooking utensil for the microwave oven may be used, and there have been suggested various types of cooking utensils for use with microwave ovens. For example, in Patent Document 1, a microwave oven cooking utensil is disclosed which has a metal pan inside the main body through which a microwave is transmitted, and a heat generating sheet arranged on the lower surface of the pan that absorbs a microwave to generate a heat.

### PRIOR ART DOCUMENT

### Patent Literature

Patent Document 1: JP Patent No. 5344638

### SUMMARY OF THE INVENTION

### Technical Problem

However, regarding the microwave oven cooking utensil disclosed in Patent Document 1, since the food material to be cooked is only heated from the lower side, it is difficult to entirely and evenly heat up the entire food material to its optimum state, thus failing to ensure a delicious food.

Moreover, in the microwave oven cooking utensil disclosed in Patent Document 1, since the food material to be cooked is heated only from the lower side while being exposed, the heat retention performance is poor. If a cooked food material is left as it is after cooking, the cooked food will cool off and fail to bring out its deliciousness, thus failing to ensure a delicious taste due to the nature of a certain food. For example, when meat is cooked, the meat will be suddenly and partially heated to become partially hard or gravy may undesirably come out.

The present invention has been accomplished in view of the above problems, and it is an object of the present invention to provide a microwave oven cooking utensil excellent in heat retention, which can entirely and evenly heat up the food material to its optimum state, thereby easily bringing out its deliciousness and thus ensuring a delicious food.

### Solution to Problem

In order to solve the above problems, the microwave oven cooking utensil of the present invention, comprises: an upper heating body and a lower heating body each of which absorbs a microwave and generates a heat; and a heating space for heating a food material located between the upper heating body and the lower heating body, the heating being performed from above and below at the same time; wherein the upper heating body and the lower heating body are each formed by including a heat generating part containing ferrite and a molded foam body.

In the present invention, the ferrite constituting the heat generating parts of the upper heating body and the lower heating body will absorb a microwave from the microwave oven and generate a heat, and such a heat can cover a food material by simultaneously heating the food material from above and below. Moreover, upon combining the heat generating part with the molded foam body, it is possible to improve a heat retention performance owing to a heat insulating effect of the molded foam body, and the cooked food material can be heated still further with a residual heat, even if the food material has been taken out from the microwave oven and left as it is . Namely, according to the above-described configuration of the present invention, using a unique heating effect and a heat retaining effect based on the synergistic effect produced by the molded foam body and the simultaneous heating effects from the upper and below, it is possible to completely and evenly heat up the food material to its optimum state and thus easily bring out the deliciousness of the food material.

In the above configuration, the heat generating part may be formed by mixing the heat generating material containing a ferrite into the molded foam body in a dispersed state. Alternatively, the heat generating part may be incorporated into the molded foam body in the form of a predetermined shape. Moreover, it is also possible for the heat generating part to be attached to the surface of the molded foam body in the form of a predetermined shape.

When the heat generating part has a predetermined shape, it is preferable that the heat generating part is a heating element having a sheet-like shape and formed by using a resin in which a ferrite powder is dispersed. This facilitates a subsequent processing and a handling, making it possible to sufficiently and effectively bring out the heat generating effect. In this way, to avoid a heat-based risk such as a burn, it is preferable that the ferrite be completely covered up with a resin and not exposed at all.

Further, in another embodiment in which the heat generating part has a predetermined shape, the heat generating part may be a heating element formed by applying or attaching a ferrite to the surface of a metal plate. In such a case, as a metal material for forming the metal plate, it is preferable to use a metal having a high thermal conductivity such as aluminum, aluminum metal alloy, copper, and copper alloy. In this way, it is possible for a heat generated by the ferrite to be transferred to the metal plate having a high thermal conductivity and to spread over the entire extending area of the metal plate, thus realizing a uniform heating (temperature distribution can be made uniform) and improving the strength of the heat generating part depending on the nature of a metal plate. Such an effect is particularly beneficial in cooking a food material such as meat. This is because when the electromagnetic waves of a microwave oven directly hit the meat or the like, the meat will absorb the electromagnetic waves and is heated from the inside of the meat, and as a result the meat tends to burst or the meat is suddenly heated and becomes hard.

Further, in the above configuration of the present invention, it is preferable that the lower heating body and the upper heating body are each formed by sandwiching the heat generating part from above and below by a molded foam body or by incorporating the heat generating part into a molded foam body. Using the heating bodies in the above-described state, it is possible for the central portion of the food material to reach a temperature of 150-200° C. Such a temperature is especially beneficial when a meat material is being cooked. This is because the Maillard reaction of meat proceeds most remarkably in the vicinity of a temperature which is 150-200° C.

Further, in the above configuration of the present invention, the upper heating body and the lower heating body are caused to sandwich the food material from above and below and come into contact with the food material. In this way, it becomes possible to directly transfer a heat to a food material to heat up the food material to its optimum heated state in a short time.

Moreover, in the above-described configuration of the present invention, it is preferable that the cooking utensil further includes a side heating body that has the same structure as the upper heating body and the lower heating body, and can heat up the food material in the heating space from the side. If such a side heating body is provided together with the upper heating body and the lower heating body, it is possible for the food material to be surrounded along its entire circumference, so as to be heated evenly and completely, thus reaching its optimum heated state in a short time.

Further, in the above configuration of the present invention, the lower heating body and/or the side heating body can be formed into a container which provides a space for accommodating a food material, and the upper heating body can be formed as a lid for closing the accommodating space. In this way, if the cooking utensil for a microwave oven is configured so that the accommodating space is formed and the accommodating space can be closed in this way, it becomes possible to cook various kinds of food materials (for example, beef stew, simmered food or the like). When the container has a handle, it is preferable that the handle does not contain ferrite so as not to generate heat or the foaming rate is increased to improve the heat insulating property in the vicinity of the handle. Therefore, the handle can be grasped with bare hands. Further, the lid only needs to close the accommodating space, and therefore, for example, it may be a “drop lid” that directly hits the food material to be cooked, or the lid is formed to close the upper opening of the container.

The present invention provides a method for manufacturing a microwave oven cooking utensil, comprising the steps of: molding step to form a molded foam body; incorporating step to incorporate a heat generating part containing ferrite that absorbs a microwave and generates a heat into the molded foam body by using a molding method including injection molding, insert molding and a two-color molding, or using a mechanical assembling method. In this case, the molding step includes: using a plasticizing cylinder having a plasticizing zone in which a thermoplastic resin is plasticized and melted to obtain a molten resin, a hungry zone in which the molten resin is in a hungry state, and an introduction port which is formed for introducing a physical foaming agent into the hungry zone; plasticizing and melting the thermoplastic resin to obtain the molten resin in the plasticizing zone; making the molten resin to be in the hungry state in the hungry zone; introducing a pressurized fluid containing the physical foaming agent at a constant pressure into the hungry zone and holding the hungry zone at the constant pressure; with the hungry zone held at the constant pressure, bringing the molten resin in the hungry state into contact with a pressurized fluid containing the physical foaming agent at the constant pressure in the hungry zone; and molding the molten resin in contact with the pressurized fluid containing the physical foaming agent into the molded foam body.

According to the manufacturing method including the above-described molding step, it is possible to perform a fine foam molding (foam cell diameter: 10-80 μm) with a lower gas pressure than the conventional physical foam molding method using a supercritical fluid. This makes it possible to perform a molding with a small molding machine and to perform a foam molding with super-engineering plastics. In this case, it is preferable that the constant pressure is 1 MPa-15 MPa. If foaming can be effected at such a low pressure in this way, it is possible to suppress blisters (later-swelling) of the molded product during heating.

Further, in such a manufacturing method, preferably the foaming rate of the molded foam body is 2 times or more, more preferably 3 times or more. By increasing the foaming rate, it is possible to obtain an increased heat insulating property for the molded foam product (resin container, the entire cooking utensil), thereby effectively improving the heat retention property of the molded foam product (resin container, the entire cooking utensil), thus making it possible to perform a cooking based on a residue heat and to expect a cooking which can be completed in a shortened time. Here, the “foaming rate” means a volume change rate when an unfoamed state is 1. Preferably, a foaming rate is 2-6 times, more preferably 3-6 times.

### Advantageous Effects of the Invention

According to the present invention, it is possible to provide an improved microwave oven cooking utensil, in which a heating space is formed for simultaneously heating a food material from above and below by using the upper heating body and the lower heating body that absorb microwaves and generate a heat; the upper heating body and the lower heating body are each formed by including a molded foam body and a heat generating part containing ferrite. Therefore, it is possible for the cooking utensil to completely and evenly heat up an entire food material to its optimum state and thus easily bring out the deliciousness of the food material. In addition, the cooking utensil is also excellent in its temperature retention property.

### BRIEF DESCRIPTION OF DRAWINGS

FIG. 1 is a cross-sectional view showing a microwave oven cooking utensil according to a first embodiment of the present invention.

FIG. 2 is a flowchart showing a method for manufacturing the microwave oven cooking utensil of the present invention.

FIG. 3 is a cross-sectional view showing a first example of a characteristic core back foam molding method of the present invention.

FIG. 4 is a cross-sectional view showing a second example of the characteristic core back foam molding method of the present invention.

FIG. 5 is a cross-sectional view showing heating bodies of various structures which have been used in demonstrating the heating performance of the microwave oven cooking utensil configured according to the first embodiment.

FIG. 6 is a diagram showing temperature measuring points on one of the heating bodies of FIG. 5.

FIG. 7 is a table showing a temperature distribution over various temperature measuring points of heating body.

FIG. 8 is a cross-sectional view showing a microwave oven cooking utensil according to a second embodiment of the present invention.

FIG. 9 is a plan view of a microwave oven cooking utensil according to a third embodiment of the present invention, in which (a) is a plan view of a lid, and (b) is a plan view of a container.

FIG. 10 is a perspective view showing the microwave oven cooking utensil of FIG. 9, in which (a) is a perspective view of a lid and (b) is a perspective view of a container.

FIG. 11 is a plan view of a microwave oven cooking utensil according to a fourth embodiment of the present invention, in which (a) is a plan view of a lid and (b) is a plan view of a container.

FIG. 12 is a perspective view of the microwave oven cooking utensil of FIG. 11, in which (a) is a perspective view of a lid and (b) is a perspective view of a container.

FIG. 13 is a cross-sectional view showing a first example in which a heat generating part has been incorporated into a molded foam body, for a container of a microwave oven cooking utensil according to the third and fourth embodiments of the present invention.

FIG. 14 is a cross-sectional view showing a second example in which a heat generating part has been incorporated into a molded foam body, for a container of a microwave oven cooking utensil according to the third and fourth embodiments of the present invention.

FIG. 15 is a cross-sectional view showing a third example in which a heat generating part has been incorporated into a molded foam body, for a container of a microwave oven cooking utensil according to the third and fourth embodiments of the present invention.

FIG. 16 is a cross-sectional view showing upper and lower heating bodies constituting a microwave oven cooking utensil according to a fifth embodiment of the present invention.

FIG. 17 is a cross-sectional view showing an embodiment in which the microwave oven cooking utensil of FIG. 16 is accommodated in a heat-resistant container.

FIG. 18 is a cross-sectional view showing an embodiment in which an upper opening of the heat-resistant container is closed with a lid, forming an accommodation illustrated in FIG. 17.

FIG. 19 is a cross-sectional view showing a modified embodiment of the upper and lower heating bodies illustrated in FIG. 16.

### DESCRIPTION OF EMBODIMENTS

Hereinafter, description will be given to explain several embodiments of the present invention with reference to the accompanying drawings.

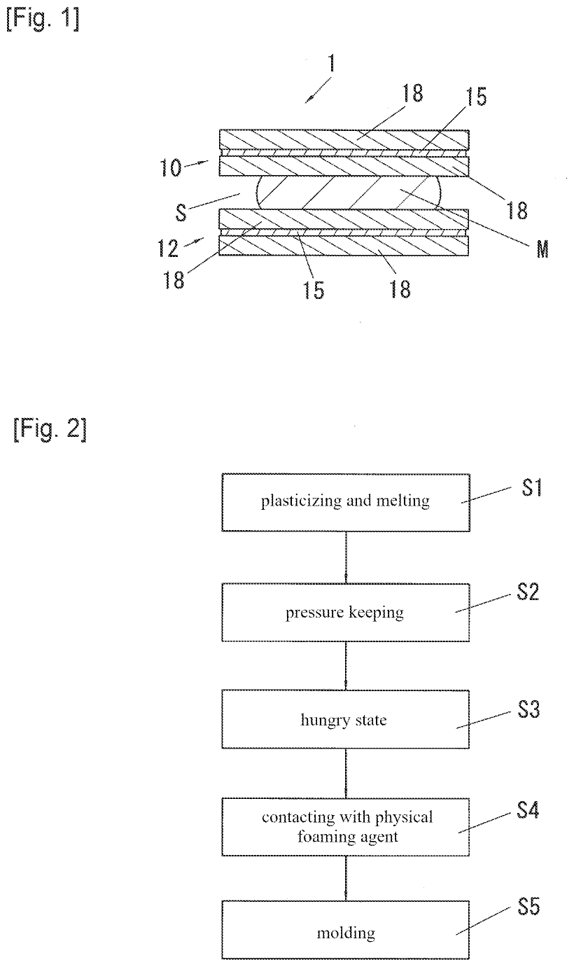

FIG. 1 shows a microwave oven cooking utensil 1 formed according to a first embodiment of the present invention. As shown in the figure, the microwave oven cooking utensil 1 of the present embodiment has an upper heating body 10 and a lower heating body 12 that absorb microwaves and generate a heat. At this time, the upper heating body 10 and the lower heating body 12 form a heating space S between the upper heating body 10 and the lower heating body 12 in which the food material (for example, meat) M is heated simultaneously from above and below.

The upper heating body 10 and the lower heating body 12 are each formed by a heat generating part 15 containing ferrite and a molded foam body 18. Specifically, in the present embodiment, the heat generating part 15 is a heating element formed into a sheet using a resin in which ferrite powder is dispersed. The upper heating body 10 and the lower heating body 12 are each formed by sandwiching the heat generating part 15 from above and below by a pair of plate-shaped foam bodies 18, 18. The upper heating body 10 and the lower heating body 12, having such a configuration, can clamp the food material M from above and below, thus coming into contact with the food material M.

In the present embodiment, the heat generating parts 15, 15 partially constituting the upper heating body 10 and the lower heating body 12 are each formed by mixing silicone resin and ferrite powder, followed by extruding the mixed material into a sheet, or die-cutting the same into a sheet or a predetermined shape, and later thermosetting that. Here, the resin is not limited to silicone, and may be a heat-resistant resin such as epoxy resin or phenol resin, or a material such as a heat-resistant elastomer which may be silicone rubber or a fluorine rubber. Alternatively, it is also possible to mix together a thermoplastic heat-resistant resin (for example, polyphenylene sulfide resin (PPS), liquid crystal polymer (LCP), aromatic polyamide (PA), polyimide, syndiotactic polystyrene (SPS), a fluororesin such as polytetrafluoroethylene) and a ferrite, followed by performing an injection molding or an extrusion molding, thereby forming the heat generating part 15. Here, the resin and the ferrite powder may be mixed in a molding machine in this way, but as another method for forming the heat generating part 15 it is also possible to in advance mix together the resin and the ferrite powder, followed by forming the same into pellets by way of extrusion molding or the like. Subsequently, the mixed pellets are introduced into an injection molding machine to finally form a heat generating part.

A ferrite constituting the heat generating part 15 is preferably a ferrite material having a Curie point at the heating temperature (for example, a Curie temperature of 220-240° C.). Specifically, such ferrite material can be MgCu ferrite powder containing 46-51 mol % of iron in terms of Fe₂O₃, 2-15 mol % of copper in terms of CuO, with the balance being magnesium oxide and unavoidable impurities. In detail, an average particle size of MgCu ferrite powder can be 2-500 μm. Alternatively, such ferrite material can be MgCuZn ferrite powder containing 46-51 mol % of iron in terms of Fe₂O₃, 2-15 mol % of copper in terms of CuO, and 27 mol % or less of zinc (but not including zero) in terms of ZnO, with the balance being magnesium oxide and unavoidable impurities. In detail, an average particle size of MgCuZn ferrite powder can be 3-500 μm.

Further, as a material for forming the molded foam body 18 constituting the upper heating body 10 and the lower heating body 12, it is possible to use a high heat resistant resin, such as syndiotactic polystyrene (SPS), polyphenylene sulfide resin (PPS), liquid crystal polymer (LCP), aromatic or semi-aromatic polyamide (PA), polyimide, polyamideimide, heat-resistant polyester, or fluororesin such as polytetrafluoroethylene, or composite materials thereof. Moreover, it is also possible to use a mixture containing two or more of the above-mentioned resins. In addition, these resins are also allowed to contain a filler consisting of inorganic particles such as glass fiber, talc, carbon fiber, and ceramic.

Using such a material, the molded foam body 18 may be formed by, for example, the following manufacturing method (see, for example, Re-publication No. 2017/007032 (Japanese Patent Application No. 2016-567053)).

Namely, the manufacturing method of the present invention employs an apparatus (not shown) in which the resin pellets are plasticized and melted by the rotation of a screw in the plasticizing cylinder, and the molten resin is then moved to the front side in the cylinder. Further, when the molten resin is moved to the front side in the cylinder, the screw is moved rearward to measure the molten resin, while the screw is moved forward at the time of injection. The cylinder has a plasticizing zone provided on the upstream side, a hungry zone provided on the downstream side, while an introduction port for introducing a physical foaming agent is provided in the hungry zone. The plasticization zone is a zone in which the thermoplastic resin is plasticized and melted to form a molten resin. The hungry zone is a zone in which the molten resin is in a hungry state. The “hungry state” means a state in which the molten resin has not filled the zone and an unfilled state is thus formed, or means a state in which the density of the molten resin is low. Therefore, a space other than those occupied by the molten resin may exist in the hungry zone.

Hereinafter, description will be given to explain a method for producing an upper heating body and a lower heating body (including the molded foam body of the present embodiment) with reference to a flowchart shown in FIG. 2.

### (1) Plasticizing and Melting a Thermoplastic Resin

First, the thermoplastic resin is plasticized and melted in the plasticizing zone of the cylinder to obtain a molten resin (step S1 in FIG. 2). As the thermoplastic resin, it is possible to use various resins according to heat resistance and the intended use of the molded body which is a purposeful target of the present invention. Specifically, it is possible to use thermoplastic resins such as polypropylene, polymethylmethacrylate, polyamide, polyethylene, polycarbonate, polybutylene terephthalate, amorphous polyolefin, polyetherimide, polyethylene terephthalate, polyetheretherketone, ABS resin (acrylonitrile/butadiene/styrene copolymer resin), polyphenylene sulphide, polyamideimide, polylactic acid, polycaprolactone, or composite materials thereof. In particular, it is preferable to use a crystalline resin because it easily forms fine cells. In practice, these thermoplastic resins may be used alone or in combination of two or more. Further, it is possible to use resins obtained by kneading these thermoplastic resins with inorganic filler such as glass fiber, talc, carbon fiber or ceramic, or organic filler such as cellulose nanofibers, cellulose and wood flour. Moreover, it is preferable for a thermoplastic resin to be mixed with an inorganic filler that functions as a foam nucleating agent, an organic filler, and an additive that increases the melting tension. By mixing these substances, it is possible for the foam cells to be made finer. Further, if necessary, the thermoplastic resin is allowed to contain various other general-purpose additives.

### (2) Maintaining a Pressure in the Hungry Zone

Next, a physical foaming agent having a constant pressure is supplied to a pressure adjusting container (not shown), and a pressurized fluid having a constant pressure is introduced from the pressure adjusting container into the hungry zone to maintain the hungry zone at the constant pressure (Step S2 in FIG. 2).

Here, a pressurized fluid is used as the physical foaming agent. In the present embodiment, the “fluid” means any of a liquid, a gas, and a supercritical fluid. A physical foaming agent is preferably a carbon dioxide, a nitrogen, a dry air or the like from the viewpoint of cost and environmental load. Since the pressure of the physical foaming agent of the present embodiment is relatively low, it is possible to use a fluid taken out from a cylinder such as a nitrogen cylinder, a carbon dioxide cylinder, or an air cylinder, whose pressure has been reduced to a constant pressure by a pressure reducing valve. At this time, since it is not necessary to use a pressure increasing device, it is possible to reduce a cost for the entire manufacturing apparatus. On the other hand, if necessary, it is also possible to use a fluid pressurized to a predetermined pressure, as a physical foaming agent. For example, when nitrogen is used as a physical foaming agent, it is possible to use the following method to generate a physical foaming agent. Namely, at first, nitrogen is extracted and purified through a nitrogen separation membrane while compressing the air in the atmosphere using a compressor. Next, the purified nitrogen is boosted to a predetermined pressure using a booster pump, a syringe pump, or the like to generate a physical foaming agent.

The pressure of the physical foaming agent introduced into the hungry zone is constant, and the pressure of the hungry zone is maintained at the same constant pressure as that of the introduced physical foaming agent. The pressure of this physical foaming agent is preferably 0.5-15 MPa, more preferably 1-10 MPa, and even more preferably 1-8 MPa. Although an optimum pressure will vary depending on the type of molten resin, if the pressure of the physical foaming agent is set at 1 MPa or more, it is possible for the physical foaming agent having an amount (necessary for foaming) to be permeated into the molten resin. If the pressure of the physical foaming agent is set at 15 MPa or less, it is possible to improve the heat resistance of the molded foam body. When the manufacturing is carried out at a pressure (high pressure) higher than 15 MPa, the foaming cells themselves of the molded foam body will be in a high pressure state, and when the molded foam body is heated to a high temperature, a phenomenon called later-expansion will occur, resulting in a low heat resistance of the molded foam body. On the other hand, when foaming is performed at a pressure (low pressure) of 15 MPa or less, it is possible to suppress the so-called later expansion, thereby improving the heat resistance of the molded foam body.

The pressure of the physical foaming agent that pressurizes the molten resin is “constant”. This means that the fluctuation range of the pressure with respect to a predetermined pressure is preferably within ±20%, more preferably within ±10%. The pressure in the hungry zone is measured, for example, by a pressure sensor (not shown) provided at a position facing the inlet of the cylinder.

### (3) Putting the Molten Resin in a Hungry State

Next, the molten resin is caused to flow into the hungry zone, thus being put in a hungry state (step S3 in FIG. 2).

### (4) Bringing the molten resin and the physical foaming agent into contact with each other.

Next, with the hungry zone being held at a constant pressure, the molten resin in the hungry state and the physical foaming agent at a constant pressure are brought into contact with each other in the hungry zone (step S4 in FIG. 2). Namely, in the hungry zone, the molten resin is pressurized with a physical foaming agent under a constant pressure. Specifically, in the hungry zone, since there is a space unfilled by molten resin (hungry state) and there is a space in which the physical foaming agent can exist, the physical foaming agent and the molten resin can be efficiently brought into contact with each other. The physical foaming agent in contact with the molten resin permeates throughout the molten resin and is thus consumed. When the physical foaming agent is consumed, the physical foaming agent staying in the pressure adjusting container is smoothly supplied to the hungry zone. As a result, the pressure in the hungry zone is maintained at a constant pressure, and the molten resin remains in contact with the physical foaming agent at a constant pressure.

Conventionally, when performing a foam molding using a physical foaming agent, a predetermined amount of a high-pressure physical foaming agent was forcibly introduced into a plasticizing cylinder within a predetermined time. Therefore, it was necessary to increase the pressure of the physical foaming agent, to accurately control an amount of the physical foaming agent being introduced, also to control the introduction time and the like. In fact, the physical foaming agent comes into contact with the molten resin only within a short introduction time. On the other hand, in the present embodiment, the physical foaming agent at a constant pressure is not forcibly introduced into the cylinder, but is continuously supplied into the cylinder and continuously brought into contact with the molten resin, such that the pressure in the hungry zone becomes constant. In this way, it is possible to stabilize the dissolution amount (penetration amount) of the physical foaming agent in the molten resin (usually determined by the temperature and pressure). Further, in the present embodiment, since the physical foaming agent is always in contact with the molten resin, it is possible to ensure that a necessary and sufficient amount of the physical foaming agent permeates into the molten resin. As a result, the molded foam body produced in the present embodiment has finer foaming cells than those formed in the conventional molding method using a physical foaming agent, even though the present embodiment uses a low-pressure physical foaming agent.

### (5) Molding the Molten Resin into Molded Foam Body

Next, the molten resin in contact with the physical foaming agent is formed into a molded foam body (step S5 in FIG. 2).

The method of forming the molded foam body is not particularly limited. It is possible to form a molded foam body using, for example, injection molding, extrusion foam molding, foam blow molding, or the like. As an injection foam molding, it is possible to use a short shot method in which the mold cavity is filled with a molten resin having a filling capacity which is 75%-95% of the mold cavity volume, thereby filling the mold cavity while the bubbles are expanding. Further, it is also possible to use a core back method in which a mold cavity is filled with a molten resin having a filling capacity which is 90%-100% of the mold cavity volume, followed by performing a foaming process while enlarging the cavity volume. The molded foam body thus obtained has foaming cells inside, and since a shrinkage of the thermoplastic resin during cooling is suppressed and a cooling strain is alleviated, it is possible to reduce sink marks and warpage, thereby obtaining a molded foam body having a low specific gravity. Using the core back foam molding, since it is possible to ensure an anisotropic rigidity in the thickness direction owing to the anisotropy of the internal foamed state, it is possible to form a plate material having a strong bending resistance by virtue of a synergistic effect based on an increased thickness.

As described above, in the present embodiment, the heating bodies 10, 12 are each formed by sandwiching a heat generating part 15 between the pair of molded foam bodies 18 formed above. However, as will be described later, it is also possible to combine the heat generating part 15 with the molded foam body 18 through injection molding, insert molding, two-color molding or a mechanical assembling method.

Next, description will be given to explain the internal structures of the heating bodies 10, 12 manufactured in the above-mentioned manufacturing method. Here, each of the heating bodies 10, 12 has a structure in which the heat generating part 15 containing ferrite is sandwiched between the molded foam bodies 18 through molding or pasting with an adhesive. Using the above-described structure, it is possible to prevent a direct contact with the heat generating part 15 during handling, and it is possible to prevent a human from being burned, even if the heating bodies 10, 12 are touched after microwave irradiation.

At this time, it is optional to change the foaming ratio of one or the other of the pair of molded foam bodies 18. Further, it is optional to form only one of the pair of molded foam bodies 18 through core back molding. Alternatively, it is optional to form both of the pair of molded foam bodies 18 using core back molding method. Anyway, it is optional to decide how to form a molded foam body (whether or not there is a phenomenon of foaming and what its foaming rate is).

As a desired example of the present embodiment, it is preferable that the heat conduction performance differs from one to the other of the pair of molded foam bodies 18. Namely, on one side of each of the heating bodies 10, 12 that comes into contact with the food material, it is necessary to increase the heat conductivity to conduct the heat of the heat generating part 15 that absorbs the microwave of the microwave oven and generates a heat to the food material for heating up the food material to an optimum temperature. On the other hand, on the other side of each of the heating bodies 10, 12 that does not come into contact with the food material, it is necessary to reduce the heat conductivity to block an outside heat after being irradiated by a microwave from the microwave oven, thereby ensuring a heat insulation cooking. In other words, for example, it is desirable to form the pair of molded foam bodies 18 which are so structured that after irradiating the food material in a microwave oven at 500 W for 60 seconds, the surface temperature on one side of each of the heating bodies 10, 12 is lower than the surface temperature on the other side.

In order to reach such a result, if the pair of molded foam bodies 18 have the same foaming ratio, it is possible to reduce the thickness of the molded foam body 18 on one side of each of heating bodies 10, 12 that comes into contact with the food material. At the same time, it is possible to increase the thickness of the molded foam body 18 on the other side of each of heating bodies 10, 12 that does not come into contact with the food material. Namely, the thickness of the molded foam body 18 on one side of each of heating bodies 10, 12 that comes into contact with the food material may be made thinner than the thickness of the molded foam body 18 on the other side of each of heating bodies 10, 12 that does not come into contact with the food material.

Alternatively, if the pair of molded foam bodies 18 have the same thickness, it is possible to reduce the foaming ratio of the molded foam body 18 on one side of each of heating bodies 10, 12 that comes into contact with the food material. At the same time, it is possible to increase the foaming ratio of the molded foam body 18 on the other side of each of heating bodies 10, 12 that does not come into contact with the food material. At this time, the manufacturing may be carried out by changing the core back amount on one side and the other side, or using the resins having different amounts of dissolved physical foaming agents on one side and the other side. In this case, an average specific gravity on one side of each of the heating bodies 10, 12 that comes into contact with the food material becomes high, while an average specific gravity on the other side of each of the heating bodies 10, 12 that does not come into contact with the food material becomes low.

Alternatively, it is also possible to respectively set the thickness and the foaming ratio of the pair of molded foam bodies 18 in a manner such that the thermal conductivities of the pair of molded foam bodies 18 are different from each other.

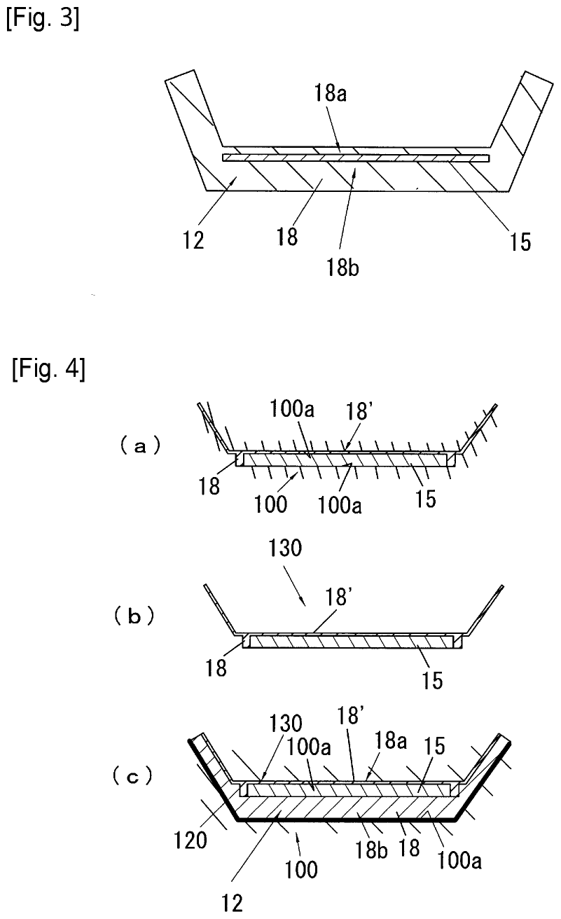

Next, FIG. 3 shows a heating body 12 which is shaped like a dish and is used as a lower heating body among the heating bodies 10, 12. Namely, the heating body 12 is molded such that one side 18a of its molded foam body 18 is formed as a thin layer having a low foaming ratio or a unfoamed thin layer, while the other side 18b of the molded foam body 18 is formed as a thick layer having a high foaming ratio.

The heating body 12 in such a molded shape can be formed by, for example, a method shown in FIG. 4. Namely, at first, the resin is poured into the mold 100 to obtain an integrally formed body including a thin-walled molded body 18′ and a heat generating part 15, using an insertion-molding method (see FIG. 4(a)), thus obtaining a preformed body 130 (see FIG. 4(b)). At this time, the preformed body 130 is formed by molding a thin molded body 18′ on only one side of the heat generating part 15. Alternatively, it is also possible to perform a foam molding based on a core back method, to make use of a skin layer occurring along the molding surface 100a, thereby forming a thin molded foam body 18′ (having a low foaming ratio) on one side of the heat generating part 15. Subsequently, the mold is changed or the same mold is used to inject resin into the mold 100 on the other side of the heat generating part 15 and foam molding is performed by using the core back method (in this case, a skin layer 120 is formed in the vicinity of the molding surface 100a of the mold 100, see FIG. 4(c)). As a result, a heating body 12 to be molded is so formed that one side 18a of the molded foam body 18 is formed as a thin layer having a low foaming rate or a unfoamed thin layer due to a thin molded body 18′, while the other side 18b of the molded foam body 18 is formed as a thick layer having a high foaming rate.

By manufacturing in this way, the thermal conductivity of one side 18a of the molded foam body 18 is high, whereas the thermal conductivity of the other side 18b of the molded foam body 18 is low, resulting in different thermal conductivities on different portions of the molded foam body. For example, molded foam body 18 is configured such that after irradiating food material in a microwave oven at 500 W for 60 seconds, the surface temperature on one side 18a of the molded foam body 18 becomes higher than the surface temperature on the other side 18b.

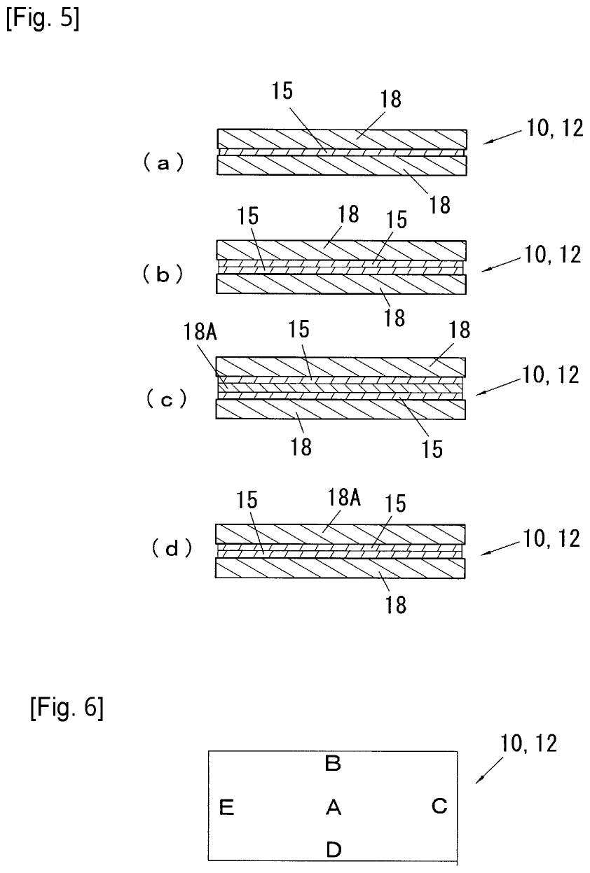

It has already been demonstrated by the inventors of the present invention that the heating bodies 10, 12 having such a sandwich structure are excellent in their heating performance. That is, the inventors of the present invention have verified the heating performance through experiments using the heating bodies 10, 12 having at least four types of structures shown in FIGS. 5(a)-5(d). In this verification experiment, the above-mentioned silicone sheet containing ferrite (heat-generating sheet) was used as the heat generating part 15, and the molded foam body 18 is a resin plate made of a food-grade heat-resistant polystyrene (syndiotactic polystyrene (SPS)), in which a glass filler was mixed in an amount of 30% by weight. The size of the resin plate was set to 200 mm×100 mm, the thickness of the resin plate was set to 3 mm, and the foaming rate of the resin plate was set to be doubled. Further, the size of the heat generating sheet was also set to approximately 200 mm×100 mm corresponding to the size of the resin plate.

The heating bodies 10, 12 having a structure shown in FIG. 5(a) are each formed by sandwiching one heat generating sheet 15 between a pair of resin plates (molded foam bodies) 18, 18. The heating bodies 10, 12 having a structure shown in FIG. 5(b) are each formed by sandwiching two heat generating sheets 15 between a pair of resin plates 18, 18. The heating bodies 10, 12 having a structure shown in FIG. 5(c), are each formed by, adhesively attaching two heat generating sheets 15, 15 to both sides of an thin intermediate resin plate (resin plate formed without foaming) 18A having a thickness of 1.5 mm, followed by sandwiching the intermediate resin plate 18A between a pair of resin plates 18, 18. The heating bodies 10, 12 having a structure shown in FIG. 5(d) are each formed by sandwiching two heat generating sheets 15, 15 between two resin plates 18, 18A. In this case, one resin plate 18 is a resin plate which has a foaming rate that is double, and the other resin plate 18A is a resin plate formed without foaming (plate thickness is 1.5 mm). Then, the resin plates and heat generating sheets are fixed together in a sandwiched state, using a polyimide heat-resistant adhesive tape. In using, the food material is sandwiched between the non-foamed resin plates 18A, and the foamed resin plates 18 are placed on the outsides away from the food material.

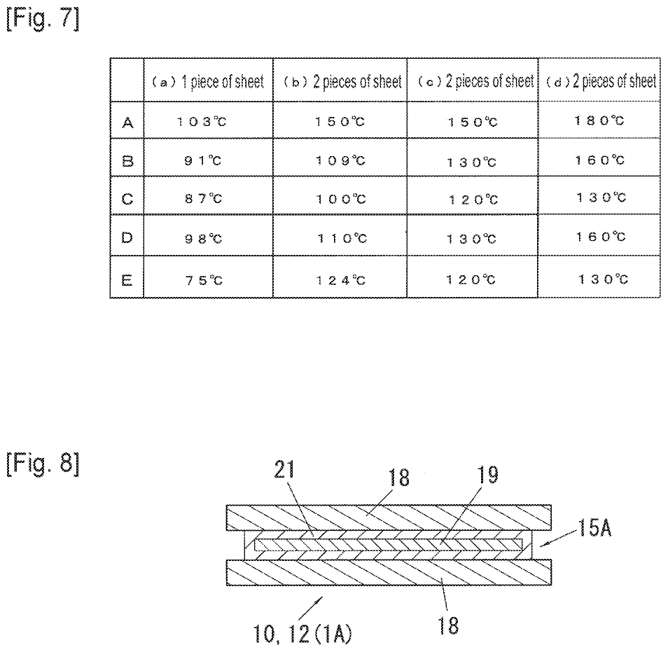

Regarding each of the four structures shown in FIGS. 5(a)-5(d), the heating bodies 10, 12 are heated in a microwave oven at 500 W for 4 minutes, the temperatures at 5 points (center position A, upper and lower positions B, D, left and right positions C, E) on the outer surfaces of the heating bodies 10, 12 shown in FIG. 6 were measured by using a thermocouple. However, regarding FIG. 5(d), the temperature of the non-foamed resin plate 18A was also measured. The measurement results are shown in FIG. 7. As can be seen from the results shown in FIG. 7, in the structures shown in FIG. 5(b) and FIG. 5(c) using the two heat generating sheets 15, 15, the temperature at the center position A has reached 150-170° C. (which is a temperature at which the Maillard reaction of meat proceeds most remarkably), thus demonstrating that the sandwich structure makes it possible to reach an optimum heating temperature. However, it should be noted that even with respect to the structure of FIG. 5(a) including one heat generating sheet 15, it is still possible to obtain the same result as the structures shown in FIG. 5(b), FIG. 5(c) by increasing an amount of ferrite. On the other hand, the temperature of the center position A of the structure shown in FIG. 5(d) is about 200° C., which is higher than those of the structures shown in FIG. 5(b) and FIG. 5(c). This is because the heat of the ferrite sheet was transferred out more by using a resin in which one side of the heating body was not foamed. Since the opposite surface is a molded foam material, the opposite surface has a heat insulating effect. Here, it should be noted that the structure shown in FIG. 5(d) corresponds to the foamed structures described above in relation to FIG. 3 and FIG. 4.

Actually, the inventors of the present invention, in an embodiment shown in FIG. 5(c), use the heating bodies 10, 12 to sandwich a food material M (which is a rib having a thickness of 3-5 mm and a loin having a thickness of 8-10 mm) from above and below, followed by heating up at 500 W for 60-90 seconds in a microwave oven. As a result, the meat was heated to a temperature around 180° C. where the Maillard reaction occurs, with the meat itself being sandwiched between the surfaces of two molded bodies being unfoamed. At this time, the ferrite constituting the heat generating parts 15 of the upper heating body 10 and the lower heating body 12 will absorb the microwave of the microwave oven and generates a heat, and the generated heat is transmitted to the molded foam bodies 18 so that the meat in contact with the molded foam bodies 18 is heated from above and below simultaneously. Subsequently, the heating by the microwave oven is stopped, the molded foam bodies of the upper heating body and the lower heating body are used to insulate heat from the outside, and the meat is heated by the residual heat of the meat itself. As a result, it became possible to bring out the deliciousness of the meat to its optimum state with the gravy trapped. Further, an increase in the amount of ferrite produced a more preferable burning.

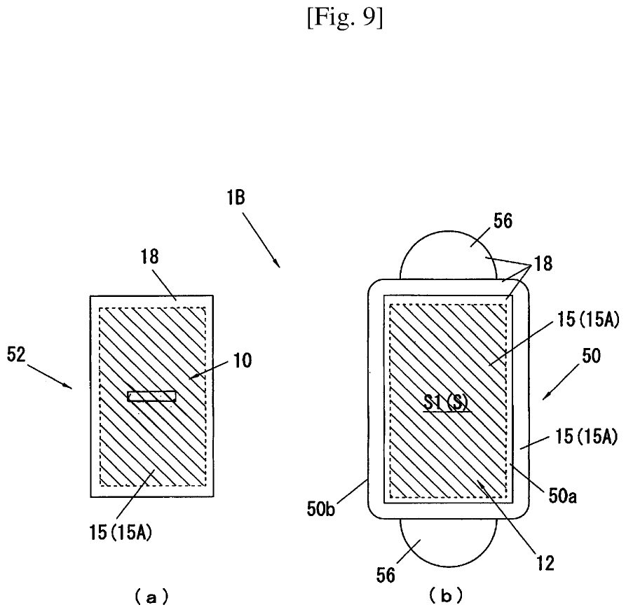

FIG. 8 shows a heating body 10 (12) constituting the cooking utensil 1A for a microwave oven according to the second embodiment of the present invention. As shown in the figure, in the heating body 10 (12) of the cooking utensil 1A for a microwave oven according to the present embodiment, the heat generating part 15A is different from that of the first embodiment. That is, the heat generating part 15A of the present embodiment is formed by applying a ferrite-containing silicone resin to the surface of a metal plate 19 and then performing a heat-curing treatment, or by attaching a ferrite-containing heat-resistant heat-generating sheet to the surface of the metal plate 19. Namely, it is formed as a heat generating part attached to the surface of the metal plate 19. In the present embodiment, the metal plate 19 is formed of an aluminum plate. Preferably, when ferrite is to be applied or attached to the aluminum plate 19 in this way, a paint formed by dispersing ferrite powder in a resin is applied to the surface of the metal plate 19 and then heat-cured, or a ferrite-containing heat-resistant resin sheet 21 is attached to the metal plate 19. As the resin in this case, an elastomer-based silicone resin is suitable, but it is also possible to use heat-resistant urethane, heat-resistant fluorine-containing rubber, or the like as the elastomer/rubber material. In addition, heat-resistant thermosetting resins such as epoxy resin, phenol resin (bakelite), and melamine resin are also suitable. A resin sheet in such a form may be integrally formed with the aluminum plate 19 by, for example, insert molding.

Examples of a metal material forming the metal plate 19 include copper, an aluminum alloy, a copper alloy and the like, in addition to aluminum. From the viewpoint of weight reduction of cooking utensils (containers), it is preferable to use aluminum or an aluminum alloy. Ceramic plates can also be used instead of metal plate.

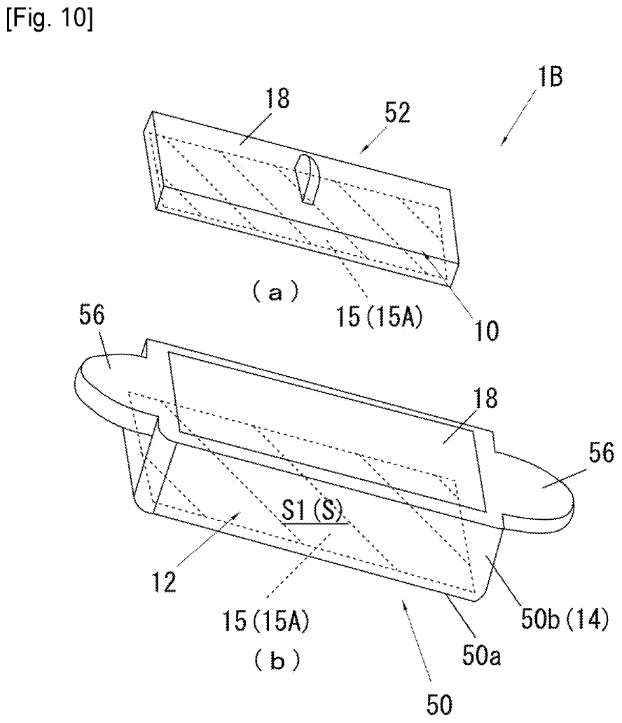

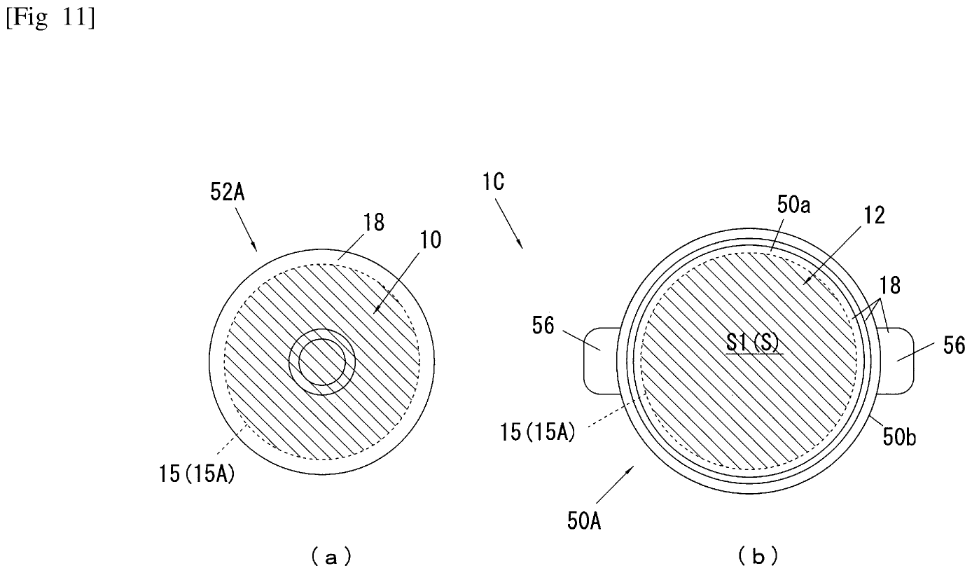

FIG. 9 and FIG. 10 show a cooking utensil 1B for use in a microwave oven, according to the third embodiment of the present invention. As shown in the figure, in the present embodiment, the lower heating body 12 forms at least a part (bottom surface 50a) of a rectangular container 50 having a U-shaped cross section (forming a storage space S1 for accommodating a food material to be cooked). The upper heating body 10 is formed as a rectangular lid 52 that closes the accommodation space S. In this case, the lid 52 only needs to close the accommodation space S1, and therefore, in the present embodiment, it is formed as a “drop lid” that directly hits the food material to be cooked. Of course, it is also possible for the lid 52 to be formed as a lid that closes the upper opening of the container 50, while the lid 52 itself does not have to come into contact with the food material. On the other hand, in the present embodiment, the peripheral side surface 50b of the container 50 may be formed by the side heating body 14. In this case, the side heating body 14 has the same structure as the upper heating body 10 and the lower heating body 12, and can heat, from the side, the food material in the accommodation space S1 which is also the heating space S. Namely, when the side heating body 14 is provided in this way, the container 50 is preferably formed by the lower heating body 12 and the side heating body 14 that have been integrally formed together. Further, as a method of providing such a side heating body 14, it is conceivable to form four peripheral side surfaces 50b of the container 50 one by one through foam molding based on a core back method. At this time, a heating body having a predetermined shape may be formed by incorporating a heat generating sheet into a molded foam body, and such a heating body may be assembled by using a joining technique such as ultrasonic bonding or laser bonding, or may be box-shaped in advance. On the other hand, when the container 50 is made as one step without separating the four peripheral side surfaces 50b, it is possible for the heat generating part 15 (15A) to be combined with the peripheral side surface 50b and the bottom surface 50a, with only the bottom surface 50a being formed using a core-back method.

Further, in the present embodiment, as described above, the heating bodies 10, 12 are each formed by incorporating into a molded foam body 18, a heat generating part 15 (shown by a shaded dashed frame in FIG. 9 and FIG. 10) based on the first embodiment and formed into a sheet shape using a resin in which the ferrite powder is dispersed, or a heat generating part 15A (shown by a shaded dashed frame in FIG. 9 and FIG. 10) based on the second embodiment and formed by applying a heat-resistant paint mixed with ferrite to the surface of a metal plate and performing a heat-curing treatment thereon, or by adhesively attaching the above-mentioned heat generating sheet to the surface of the metal plate. More specifically, for example, it is possible to utilize a foam molding method (having a foaming rate of 2 times or more) described in FIG. 2, using a highly heat-resistant resin such as a filler-added syndiotactic polystyrene (SPS), a polyphenylene sulfide resin (PPS), a liquid crystal polymer (LCP), an aromatic polyamide (PA) and the like, thus integrally forming together the container 50 and the heat generating part 15 (15A) by two-color molding at the same time the container 50 is molded. At this time, it is preferable that the handle 56 of the container 50 does not contain ferrite and the foaming rate be increased in order to provide a heat insulating property, thus ensuring that the container 50 can be grasped by bare hands.

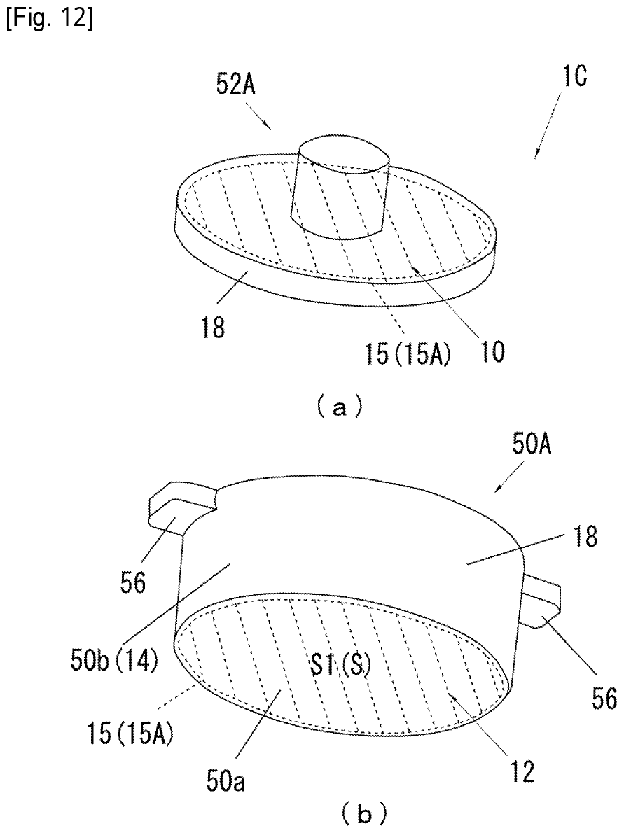

FIG. 11 and FIG. 12 show the cooking utensil 1C for a microwave oven according to the fourth embodiment of the present invention. As shown, the microwave oven utensil 1C of the present embodiment is different from the third embodiment only in the shapes of the container and the lid, and is the same as the third embodiment except for the shapes of the container and the lid. Namely, in the present embodiment, the lower heating body 12 forms at least a part (bottom surface 50a) of the cylindrical container 50A which constitutes an accommodating space Si for accommodating the food material being cooked, while the upper heating body 10 is formed as a circular lid 52A (for example, a drop lid) that closes accommodating space S. On the other hand, the peripheral side surface 50b of the container 50 may be formed by the side heating body 14.

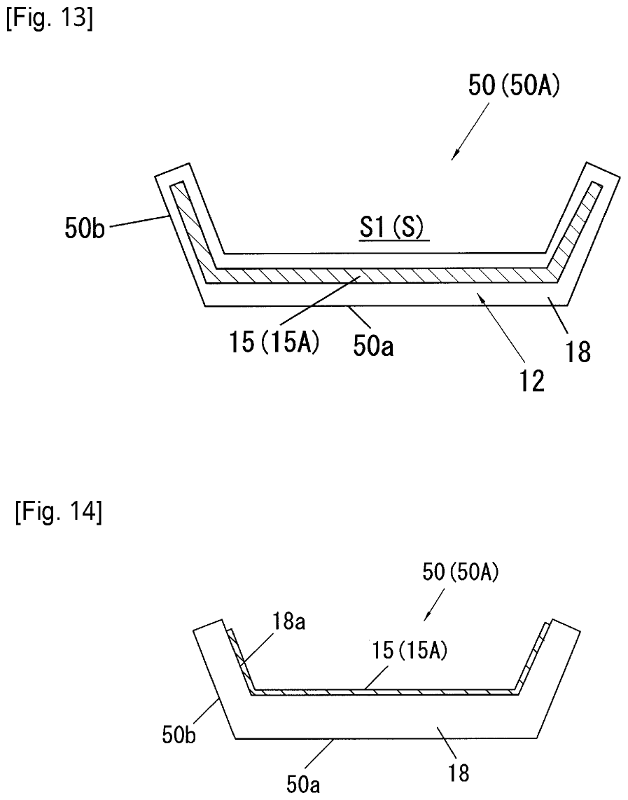

FIG. 13-FIG. 15 show three different examples in which the heat generating part 15 (15A) is incorporated into the molded foam body 18 in the container 50 (50A) of the microwave oven cooking utensils 1B, 1C according to the third and fourth embodiments described above.

In the container 50 (50A) shown in FIG. 13, the heat generating part 15 of the first embodiment or the heat generating part 15A of the second embodiment is incorporated into the container-shaped molded foam body 18 through insert-molding. Here, the heat generating part 15 is container-shaped and formed into a sheet-like material using a resin in which the ferrite powder has been dispersed, the heat generating part 15A is formed by applying a heat-resistant paint mixed with ferrite to the surface of a metal plate and performing a heat-curing treatment thereon, or by adhesively attaching the above-mentioned heat generating sheet containing ferrite to the surface of the metal plate. Alternatively, rather than forming such a resin sheet or metal plate containing ferrite, it is possible to incorporate the above-mentioned heat-resistant resin pellets containing ferrite into a molded foam body 18 made of a heat-resistant resin (SPS) or the like by two-color molding or a similar method. Here, the heat-resistant resin pellets are those formed by in advance mixing together heat-resistant resin (SPS) and ferrite powder, followed by extrusion molding.

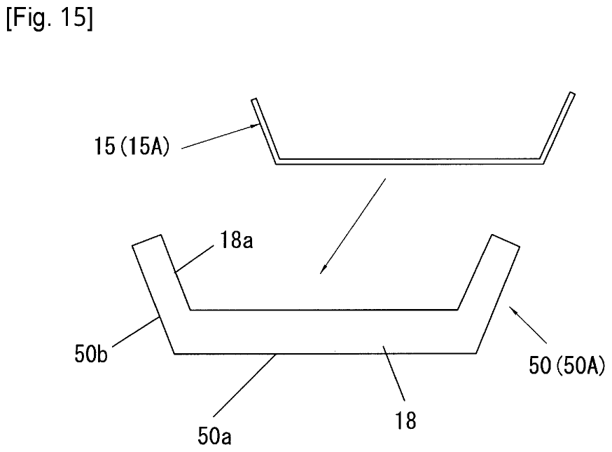

In the container 50 (50A) shown in FIG. 14, the above-mentioned heat generating parts 15, 15A each having an inner surface are laminated together and integrally formed on the inner surface 18a of the container-shaped molded foam body 18 in an exposed state. Further, as shown in FIG. 15, separately formed heat generating parts 15, 15A each having an inner surface on the inner surface 18a of the container-shaped molded foam body 18 are exposed and mechanically assembled, for example, by caulking. Preferably, the entire surface of the heat generating parts 15, 15A be coated with a high-hardness heat-resistant resin or the like, such that the heat generating parts will not be scraped away when being rubbed with a scrubbing brush or the like during washing.

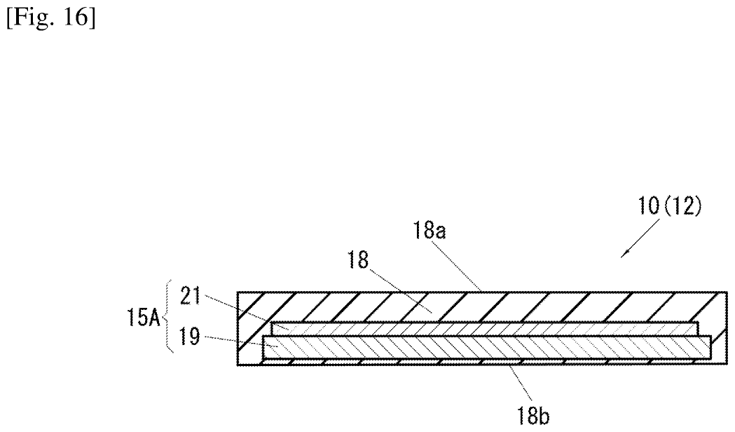

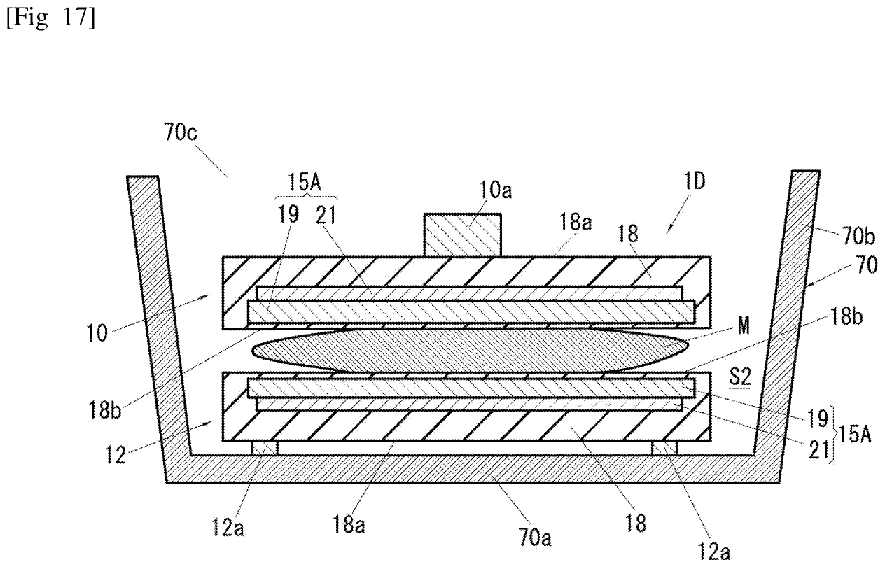

FIG. 16 and FIG. 17 show the cooking utensil 1D for a microwave oven according to the fifth embodiment of the present invention. The upper and lower heating bodies 10, 12 constituting the cooking utensil 1D for a microwave oven are each formed by applying a silicone resin containing ferrite to the surface of a metal plate 19 and performing a heat-curing treatment thereon, as clearly shown in FIG. 16 and described in the second embodiment. Alternatively, the upper and lower heating bodies 10, 12 are each formed by at first attaching a ferrite-containing heat-resistant heat-generating sheet to the surface of the metal plate 19, followed by covering the entire circumference of the heat generating part 15A with a molded foam body 18, thereby finally obtaining the upper and lower heating bodies 10, 12. In particular, in the present embodiment, the metal plate 19 is formed of an aluminum plate, and a ferrite-containing heat-resistant resin sheet 21 is attached to the surface of the metal plate 19 to form a heat generating part 15A. That is, the upper and lower heating bodies 10, 12 constituting the cooking utensil 1D for a microwave oven of the present embodiment, are each formed by embedding a metal plate 19 and a ferrite-containing heat-resistant resin sheet 21 (adjacent to each other) into the molded foam body 18.

The heat generating part 15A, the molded foam body 18, and the metal plate 19 are similarly formed by using the same materials as those in the first embodiment and the second embodiment. Namely, for example, the material 21 obtained by kneading the ferrite powder into the resin is applied to one or both surfaces of the metal plate 19, or the material 21 obtained by kneading the ferrite powder into the resin and the metal plate 19 are integrally combined together through insert-molding, while the upper and lower heating bodies 10, 12 are formed by covering the heat generating part 15A (formed in this way after thermosetting or calcining) with a heat-resistant resin (molded foam body 18). Alternatively, a molded body (foam molded body 18) is formed in advance using a heat-resistant resin, and the heat generating part 15A formed as described above is combined to this molded body, by using an adhesive and or by way of laser welding, thereby realizing an integration. Further, as another different method, it is possible to bond the heat generating part 15A to the resin plate (molded foam body 18), followed by coating the surface thus formed with a heat resistant coating material.

As shown in FIG. 17, the heating bodies 10, 12 each having the metal plate 19 can uniformly heat the food material M sandwiched between the heating bodies 10, 12. Further, when the metal plates 19 are provided in this way, it is preferable to arrange the upper and lower heating bodies 10, 12 with the metal plate 19 facing the food material M. Consequently, the food material M can be heated even more uniformly. At this time, as shown in the figure, it is preferable to make the layer thickness of the part 18b (located close to the metal plate 19, and in contact with the food material M) of the molded foam body 18 thin. Alternatively, it is preferable to make this part 18b which is not foamed at all. In this way, it becomes possible to easily transfer the heat generated from the heat generating part 15A to the food material M being cooked. On the other hand, it is preferable to make the layer thickness (to ensure a high foaming rate) of the part 18a of the molded foam body 18 (which is located on the side opposite to the metal plate 19 and therefore not in contact with the food material M) thick. As a result, it is possible to enhance the heat insulating effect of the cooking utensil 1D.

As shown in FIG. 17, the cooking utensil 1D arranged by sandwiching the food material M from above and below by the upper and lower heating bodies 10, 12 is placed into a microwave oven (not shown) to be heated. Here, the cooking utensil 1D is placed into a microwave oven in the state of arranged into an inner accommodating part S2 of a bottomed cylindrical non-metal heat-resistant container 70 (formed of ceramic, glass, heat-resistant resin or the like) having a bottom part 70a and a peripheral side part 70b. At this time, preferably the lower heating body 12 placed on the bottom 70a of the container 70 is provided with legs 12a on the lower surface thereof, so that the lower heating body 12 does not come into direct contact with the bottom 70a of the heat-resistant container 70. Such legs 12a provide a gap between the bottom part 70a of the heat-resistant container 70 and the lower heating body 12, such that the fingers of a human hand can be inserted into the gap, making it easy to take out the lower heating body 12 from the heat-resistant container 70. Further, in relation to such an ease of heating body removal, it is preferable that the upper heating body 10 be also provided with a handle 10a on the upper surface thereof, so that the upper heating body 10 can be grasped by the fingers of a human hand.

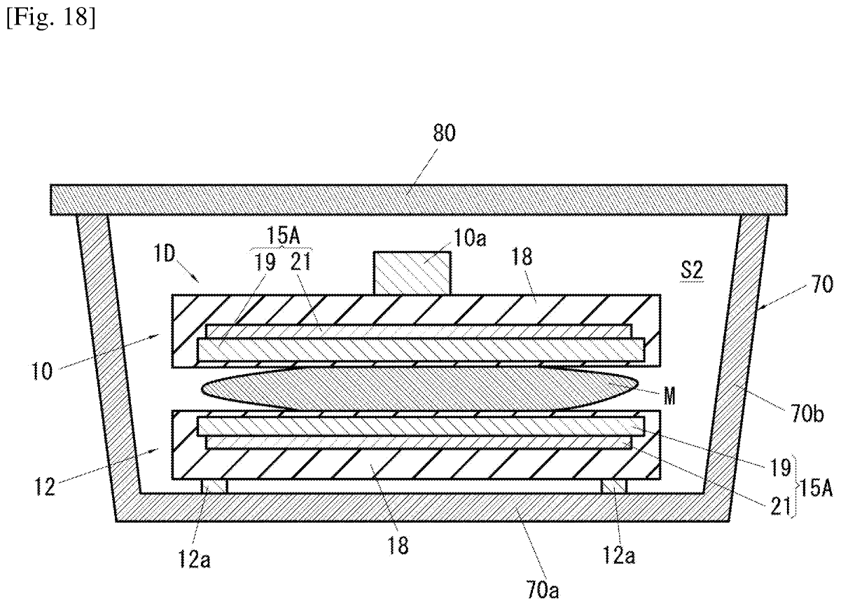

Further, when the cooking utensil 1D is accommodated into the heat-resistant container 70 and put into the microwave oven in this way, the upper opening 70c of the heat-resistant container 70 is closed by the lid 80, so that the inner accommodating part S2 may be sealed to the outside as shown in FIG. 18. In this way, it is possible to improve the heat retention performance.

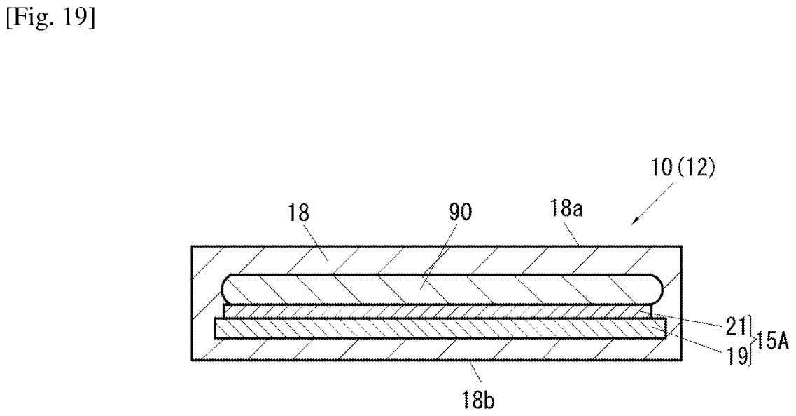

In addition, FIG. 19 shows a modified embodiment of the upper and lower heating bodies 10, 12 constituting the microwave oven cooking utensil 1D shown in FIG. 16. In this modification, glass wool 90 is provided adjacent to the heat generating part 15A to enhance the heat insulating effect. The glass wool 90 for heat insulation is arranged on the side opposite to the metal plate 19 with respect to the ferrite-containing heat-resistant resin sheet 21 (embedded in the thick portion 18a of the molded foam body 18 which is not in contact with the food material M). Such an arrangement can contribute to heat insulation in the same extent as the molded foam body 18. On the other hand, in this modified embodiment, to ensure an easy heat transfer from the heat generating part 15A to the food material M, the layer thickness of the part 18b of the molded foam body 18 close to the metal plate 19 (therefore, in contact with the food material M) is set to be a thin.

Although various embodiments of the present invention have been described above, according to the present invention, the ferrite materials constituting the heat generating parts 15, 15A of the upper heating body 10 and the lower heating body 12 (or the side heating body 14) will absorb microwaves from a microwave oven and generate a heat, and the heat thus generated can be used to simultaneously heat up the food material M from above and below, with the food material being sandwiched therebetween. Moreover, by combining the heat generating parts 15, 15A with the molded foam body 18, the heat retention property will be enhanced due to the heat insulating effect of the molded foam body 18, and even if the heated food material is taken out from the microwave oven after heating and left as it is, the residual heat will remain to further heat the food material using the residue heat. Namely, according to the present invention, it is possible to evenly heat the entire food material M to an optimal state, thereby easily bringing out the deliciousness of the food material M. This is owning to a unique heating and heat retaining function produced by the synergistic effects of the molded foam body 18 and the simultaneous heating from the upper and lower heating bodies 10, 12.

In particular, as in the second embodiment described above, the heat generating part 15A is formed by applying a heat-resistant resin paint mixed with ferrite to the surface of a metal plate and performing a heat-curing treatment thereon, or by attaching the above-mentioned ferrite-containing heat-generating sheet to the surface of the metal plate, thereby producing a heat generating parts. In this way, the heat generated by the ferrite is transmitted to the metal plate 19 and spreads over the entire extending area of the metal plate 19, so that uniform heating can be realized (the temperature distribution can be made uniform) and it is possible to improve the strength of the heat generating part 15A depending on the nature of metal material. In addition, there has also been an effect that it is possible to suppress an ingression of an electromagnetic wave (microwave) by virtue of the metal plate 19.

Further, when the upper heating body 10 and the lower heating body 12 sandwich the food material from above and below and come into contact with the food material as in the above-described embodiment, the heat can be directly transferred to the food material to heat up the food material to its optimum state in a short time.

Moreover, as in the third and fourth embodiments described above, if the side heating body 14 is further provided which has the same structure as the upper heating body 10 and the lower heating body 12, and is capable of heating the food material in the heating space S from the side, it is possible to completely surround the entire circumference of the food material, and evenly heat up the food material to its optimum state within a short time.

In addition, as in the third and fourth embodiments described above, if the lower heating body 12 and/or the side heating body 14 is formed into the container 50 providing an internal space S1 for accommodating the food material, and if the upper heating body 10 is formed as a lid 52 for closing the internal space S1, it is possible to heat up and cook various kinds of food materials (for example, beef stew, simmered food or the like).

Moreover, in the above embodiments, the foaming agent has been described as a physical foaming agent, but the present invention is not limited to this example, and it is also possible to use a chemical foaming agent, or to use both the physical foaming agent and chemical foaming agent.

The present invention should not be limited to the above-described embodiments, and can be variously modified and implemented without departing from the gist of the invention. For example, a part or all of the above-described embodiments may be re-combined within a range that does not deviate from the gist of the present invention, or apart of the configuration of the invention may be omitted from one of the above-described embodiments.

### LIST OF REFERENCE SIGNS

1, 1A, 1B, 1C, 1D: microwave oven cooking utensils

10: upper heating body

12: lower heating body

15,15A: heat generating parts (heat generating elements)

18: molded foam body

19: metal plate

50: container

52: lid body

M: food material

S: heating space

S1: accommodating space

1. A microwave oven cooking utensil, comprising:
an upper heating body and a lower heating body each of which absorbs a microwave and generates a heat; and
a heating space for heating a food material located between the upper heating body and the lower heating body, the heating being performed from above and below at the same time;
wherein the upper heating body and the lower heating body are each formed by including a heat generating part containing ferrite and a molded foam body.

2. The microwave oven cooking utensil according to claim 1, wherein the heat generating part is a heating element having a sheet-like shape and formed by using a resin in which a ferrite powder is dispersed.

3. The microwave oven cooking utensil according to claim 1, wherein the heat generating part is a heating element formed by applying or attaching a ferrite to the surface of a metal plate.

4. The microwave oven cooking utensil according to claim 1, wherein the lower heating body and the upper heating body are each formed by sandwiching the heat generating part from above and below by a molded foam body.

5. The microwave oven cooking utensil according to claim 1, wherein the lower heating body and the upper heating body are each formed by incorporating the heat generating part into a molded foam body.

6. The microwave oven cooking utensil according to claim 4, wherein one side of the molded foam body that is in contact with the food material is formed as a thin layer having a low foaming rate, while the other side of the molded foam body that is not in contact with the food material is formed as a thick layer having a high foaming rate.

7. The microwave oven cooking utensil according to claim 4, one side of the molded foam body that is in contact with the food material is formed as an unfoamed thin layer, and the other side of the molded foam body that is not in contact with the food material is formed as a thick layer having a high foaming rate.

8. The microwave oven cooking utensil according to claim 6, wherein a glass wool is provided on the other side of the molded foam body.

9. The microwave oven cooking utensil according to claim 1, wherein the upper heating body and the lower heating body are arranged to sandwich the food material from above and below and come into contact with the food material.

10. The microwave oven cooking utensil according to claim 1, wherein the cooking utensil further includes a side heating body that has the same structure as the upper heating body and the lower heating body, and can heat up the food material in the heating space from the side.

11. The microwave oven cooking utensil according to claim 1, wherein the lower heating body is formed as at least a part of a container forming a space for accommodating a food material, and the upper heating body is formed as a lid for closing the accommodating space.

12. The microwave oven cooking utensil according to claim 10, wherein the lower heating body and the side heating body are formed into a container which provides a space for accommodating a food material, and the upper heating body is formed as a lid for closing the accommodating space.

13. A method for manufacturing a microwave oven cooking utensil, comprising the steps of:
molding step to form a molded foam body;
incorporating step to incorporate a heat generating part containing ferrite that absorbs a microwave and generates a heat into the molded foam body by using a molding method including injection molding, insert molding and a two-color molding, or using a mechanical assembling method;
the molding step includes:
using a plasticizing cylinder having a plasticizing zone in which a thermoplastic resin is plasticized and melted to obtain a molten resin, a hungry zone in which the molten resin is in a hungry state, and an introduction port which is formed for introducing a physical foaming agent into the hungry zone;
plasticizing and melting the thermoplastic resin to obtain the molten resin in the plasticizing zone;
making the molten resin to be in the hungry state in the hungry zone;
introducing a pressurized fluid containing the physical foaming agent at a constant pressure into the hungry zone and holding the hungry zone at the constant pressure;
with the hungry zone held at the constant pressure, bringing the molten resin in the hungry state into contact with a pressurized fluid containing the physical foaming agent at the constant pressure in the hungry zone; and
molding the molten resin in contact with the pressurized fluid containing the physical foaming agent into the molded foam body.

14. The manufacturing method according to claim 13, wherein the constant pressure is 1 MPa-15 MPa.

15. The manufacturing method according to claim 13, wherein the foaming rate of the molded foam body is 2 times or more.

16. The microwave oven cooking utensil according to claim 5, wherein one side of the molded foam body that is in contact with the food material is formed as a thin layer having a low foaming rate, while the other side of the molded foam body that is not in contact with the food material is formed as a thick layer having a high foaming rate.

17. The microwave oven cooking utensil according to claim 5, one side of the molded foam body that is in contact with the food material is formed as an unfoamed thin layer, and the other side of the molded foam body that is not in contact with the food material is formed as a thick layer having a high foaming rate.

18. The microwave oven cooking utensil according to claim 7, wherein a glass wool is provided on the other side of the molded foam body.

19. The microwave oven cooking utensil according to claim 16, wherein a glass wool is provided on the other side of the molded foam body.

20. The microwave oven cooking utensil according to claim 17, wherein a glass wool is provided on the other side of the molded foam body.
